(19) United States
(12) Patent Application Publication
(10) Pub. No.: US 2011/0306370 A1
(43) Pub. Date: Dec. 15, 2011

(54) RECEIVER SYSTEM, METHOD FOR ARRANGING THE RECEIVER SYSTEM AND POSITIONING SYSTEM COMPRISING THE RECEIVER SYSTEM

(75) Inventors: Junhui ZHAO, Beijing (CN); Takahiro SUGIYAMA, Beijing (CN)

(73) Assignee: NEC (CHINA) CO., LTD., Beijing (CN)

(21) Appl. No.: 13/024,976

(22) Filed: Feb. 10, 2011

(30) Foreign Application Priority Data
Jun. 9, 2010 (CN) 201010200654.0

(51) Int. Cl. H04B 7/00

(52) U.S. Cl. 455/500

(57) ABSTRACT

The present application discloses a receiver system for positioning, a method for arranging the receiver system, and a positioning system comprising the receiver system. The receiver system may comprise a group of nodes, the group of nodes comprising receive nodes for receiving a ranging signal. In this group of nodes, the receive nodes may be arranged according to a predetermined mode. Further, the group of nodes may comprise a reference node, and locations of other receive nodes within this group of nodes may be determined based on information on the predetermined mode and location of the reference node. With the present invention, the receiver system may have a more flexible structure, which may be better adapted to complex situations in practical application. At the same time, the calibration workload in a complex application situation can be significantly reduced.

### FIELD OF THE INVENTION

The present invention relates to a positioning technology, and more particularly, relates to a receiver system for positioning, a method for arranging the receiver system, and a positioning system comprising the receiver system.

### BACKGROUND OF THE INVENTION

In a pervasive computing scenario, a Localization and Tracking System (LTS) is required to provide positioning services so as to enhance existing applications and support new applications. Currently, there is an increasing demand on highly accurate tracking of people and assets in various application fields such as warehouse, coalmine, subway, smart building, healthcare, and restaurant, etc.

For example, in warehouse, the accurate positions of goods are required to be tracked in real time for the purpose of efficient goods management. Typical examples may comprise steel goods tracking in a steel factory, and commodity tracking in a retail warehouse, etc. Especially for those goods which are sensitive and even dangerous to human, they have a higher priority to be tracked and monitored through the Localization and Tracking system so as to record movement of the goods and the people who access to them, so that it may provide proof to verify whether they have been tampered or accessed by unauthorized persons.

Additionally, in office environment, employees are allowed to access confidential information database only in a certain secure area. Out of such certain secure area, any access to the database will be prohibited. For example, members of different groups can only access the group-dependent information database at their own working zone, and some secure computers can be used only when they are located in a certain area. All of these policies may be implemented on the basis of using LTS.

Besides, the LTS may also be found an application in a hospital. In the hospital, medical staff and instruments may be tracked in real time by using the LTS, such that record keeping and workflow can be significantly simplified. For example, when a doctor approaches to a patient, relevant records just pop up on his laptop automatically, and a form has been filled out with the current data and time, so the doctor just needs to record additional details of this interaction.

Further, LTS may further provide location information of soldiers, policemen, firemen and the like as well as location information of their targets, thereby helping then to perform their tasks efficiently.

Although there are a lot of existing LTS in current markets, it is still very challenging to realize a LTS for accurate and robust tracking of people and asset in real application scenario while it is flexible to use.

It is known that a Global Positioning System (GPS) may provide a target's location information with an accuracy of tens of meters outdoors. However, in an indoor environment, the prevision of GPS positioning results will be further degraded because of multipath effect and signal obstruction. Moreover, the precision of tens of meters provided by the GPS is rather improper for many indoor applications.

In general, the positioning system is based on three technologies: infrared, radio frequency (RF), and ultrasound. In the paper RADAR: An In-Building RF-based User Location and Tracking System in IEEE INFOCOM, 2000 by P. Bahl et al, there is disclosed a positioning system based on received signal strength of 802.11 wireless network. Positioning of the positioning system is performed in two phases. First, an off-line phase, in which phase the system is calibrated and a model is constructed by signal strengths at a finite number of locations distributed around the target area. Second, an on-line operation phase in the target area, in which phase a mobile unit reports the signal strengths received from each base station, and the system determines a best match between the on-line observation and a point in the on-line model, thereby obtaining the location of the best match point and using it as a location estimate.

Besides, “A New Location Technical for Active Office”, i.e., a “BAT” system, is disclosed in IEEE Personal Communications, Volume 4, no. 5, October 1997. For the convenience of depiction, reference will be made to FIGS. 1 and 2 to describe the system briefly, wherein FIG. 1 and FIG. 2 shows the BAT system in the prior art and the work flow thereof, respectively.

As shown in FIG. 1, the system 100 comprises a receiver array 101, a server 102, a controller 103, and a tag device 104 (including an ultrasonic transmitter). The receiver array 101 is arranged on a ceiling of a room and includes a plurality of receivers capable of receiving ultrasonic signals, the receiver array having a square or rectangular structure and being arranged in an array of a N*M dimension. The tag device 104 includes an ultrasonic transmitter capable of transmitting ultrasonic signals, and the tag device 104 is attached to an object to be tracked. The server 102 is connected to the receiver array, for receiving measurement data from the receiver array and performing location calculation. The server 102 is connected to the controller 103, the controller being for transmitting a wireless message including tag ID to the tag device 104, the tag ID or address being determined by the server 103.

FIG. 2 shows a working flow of the system. As shown in FIG. 2, at step 201, the controller 103 first broadcasts the tag ID via RF, the tag ID being assigned by the server 102. Meanwhile, at step 202, the server 102 synchronizes the receivers in the receiver array 101, for example transmitting a sync signal to the receiver array 101 so as to start each receiver in the receiver arrange and perform synchronization. Next, at step 203, the tag device 104 corresponding to the tag ID receives the tag ID broadcast from the controller 103, and as a response, emits an ultrasonic signal for ranging. At step 204, the receiver array detects the ultrasonic signal and obtains the time of arrival (TOA) data. Next, at step 205, the receiver array 101 reports the TOA data to the server. Next, the receiver array can enter into a power save mode. Finally, the server calculates a 3D location of the target based on the received TOA data.

However, the above LTS system has a rather inflexible architecture and a complex coordination mechanism, and it is thus hard to be put into the practical application.

### SUMMARY OF THE INVENTION

In view of the above, the prevent invention discloses a positioning technique more suitable for practical application.

According to a first aspect of the present invention, there is provided a receiver system for positioning. The system may comprise: a group of nodes comprising receive nodes for receiving a ranging signal, where in the group of nodes, the receiver nodes are arranged in a predetermined mode, the group of nodes may comprise a reference node, and locations of other receive nodes within the group of nodes may be determined based on information on the predetermined mode and the location of the reference node.

In an embodiment of the present invention, the receive nodes may be arranged in a straight line at a predetermined interval.

In another embodiment of the present invention, a reference node may be determined as one of the receive nodes, and locations of the other receive nodes may be determined based on the direction of the straight line, the predetermined interval, the coordinates of the reference node and its order in the group of receive nodes.

In a further embodiment of the present invention, the reference node may be determined as two receive nodes among the receive nodes, and locations of the other receive nodes may be determined based on the direction of the straight line, the predetermined interval, the coordinates of one of the two receive nodes and its order in the group of receive nodes, wherein the direction of the straight line is determined based on the coordinates of the two receive nodes.

In a still further embodiment of the present invention, these two receive nodes may be a head receive node and a tail receive node among the receive nodes.

In a further embodiment of the present invention, the receive nodes may be arranged in conformity with a predetermined circle at a predetermined interval, wherein the reference node may be determined as one of the receive nodes, and locations of other receive nodes may be determined based on the center of the circle, the radius of the circle, the predetermined interval, and the coordinates of the reference node.

In a still further embodiment of the present invention, at least one of the receive nodes may be a sync node configured to further receive a sync signal for synchronizing the receive nodes.

In a further embodiment of the present invention, the receiver system comprises a plurality of groups of nodes, wherein at least one group of nodes is arranged in a different plane from other group of nodes.

In a yet further embodiment of the present invention, receive nodes in the plurality of groups of nodes are connected into a node chain through a cable.

In a further embodiment of the present invention, the plurality of receive nodes are connected in a straight line, a W-line, or combination thereof.

According to a second aspect of the present invention, there is provided a method for arranging a receiver system. The method may comprise: arranging receive nodes of the receiver system by a group of nodes according to a feature of a surface to be arranged; and arranging the receive nodes within the group of nodes in a predetermined mode; wherein the group of nodes comprises a reference node, and locations of other receive nodes within the group of nodes may be determined based on information on the predetermined mode and location of the reference node.

According to a third aspect of the present invention, there is further provided a receiver system comprising the first aspect of the present invention.

According to the embodiments of the present invention, the receiver system has a flexible architecture, is applicable to a complex structure with varying scenarios, and may reduce the calibrated workload in practical application. Further, over the prior art, the receive system of the present invention also achieves an effective coordination and may reach a relatively high precision.

### BRIEF DESCRIPTION OF THE DRAWINGS

The above and other features of the present invention will become more apparent through detailed description of the embodiments taken with reference to the accompanying drawings of the present invention in which like reference signs indicate like or similar components:

FIG. 1 shows a diagram for a system architecture of an ultrasonic positioning system according to the prior art;

FIG. 2 shows a diagram for a work flow of an ultrasonic positioning system according to the prior art;

FIG. 3 shows a diagram for a system architecture according to an embodiment of the present invention;

FIG. 4A shows an exemplary receiver system according to an embodiment of the present invention;

FIG. 4B shows an exemplary group of nodes of a receiver system according to the present invention;

FIG. 4C and FIG. 4D show an exemplary receiver system according to other embodiments of the present invention;

FIGS. 5A to 5D show a node connection manner according to an embodiment of the present invention;

FIG. 6 shows a diagram for a work flow of a positioning system according to an embodiment of the present invention;

FIG. 7 shows a time chart of a positioning system according to the present invention; and

FIG. 8 shows a flow chart of a method for arranging a receiver system according to an embodiment of the present invention.

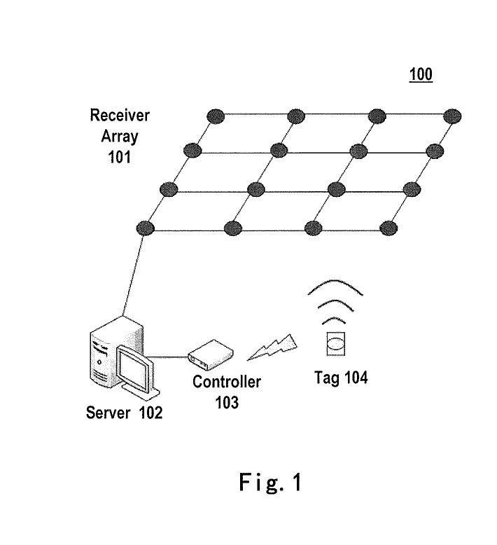

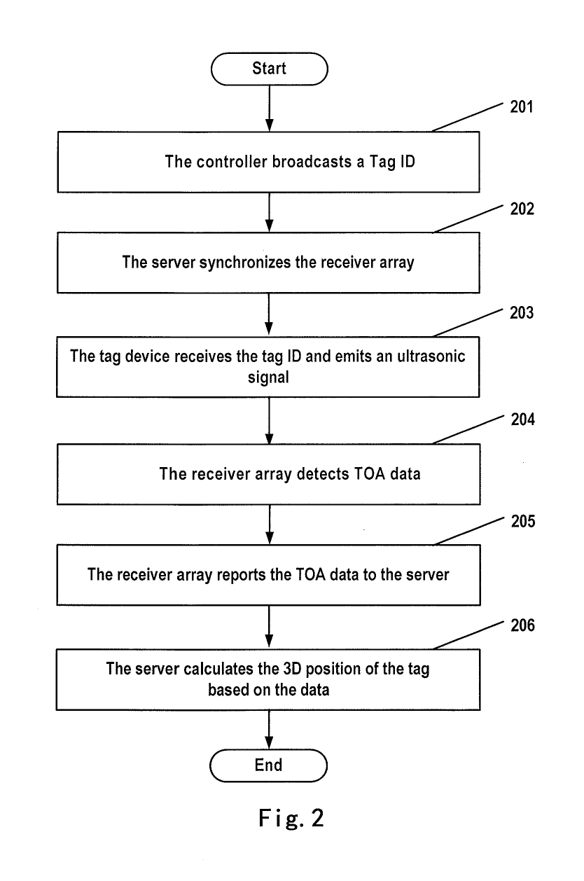

### DETAILED DESCRIPTION OF THE PREFERRED EMBODIMENTS

Hereinafter, detailed description will be made on a receiver system for positioning, a method for arranging the receiver system, and a positioning system comprising the receiver system as proposed by the present invention through embodiments with reference to the accompanying drawings.

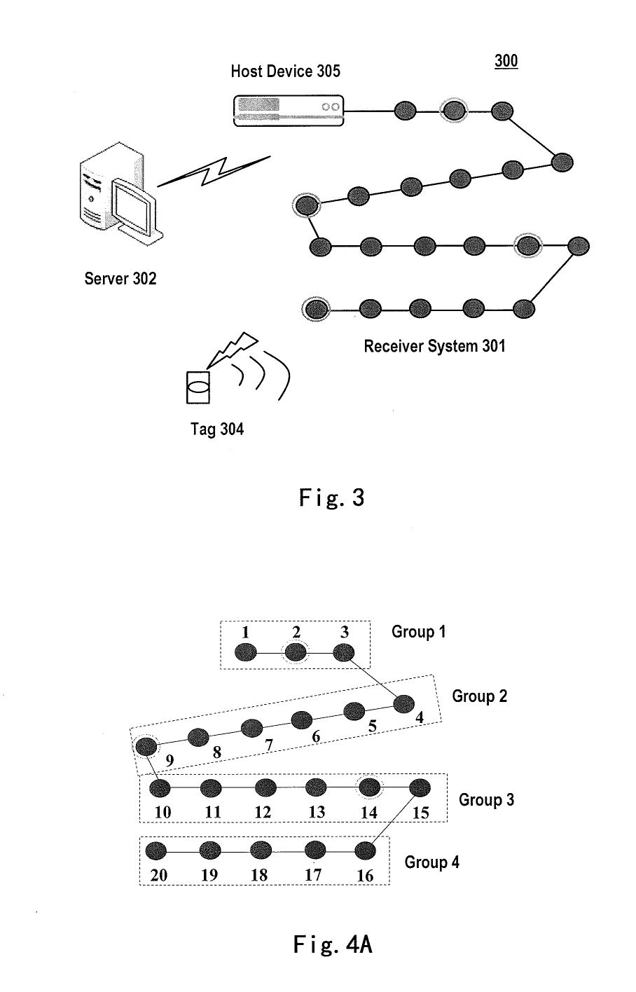

First, reference will be made to FIG. 3 to depict a positioning system according to the present invention. FIG. 3 shows a diagram for a system architecture according to an embodiment of the present invention.

As shown in FIG. 3, the system according to the present invention may comprise a receiver system 301, a server 302, a tag device 304, and a host device 305, wherein, the receiver system 301 comprises a plurality of receive nodes which may be mounted on for example an indoor ceiling. The receiver system 301 is configured to receive a ranging signal, for example an ultrasonic signal, emitted from the tag device 304, to detect TOA data. The host device 305 is configured to collect TOA data detected by the receiver system 301 and perform system coordination; the server 302 is configured to calculate the location of the tag based on the TOA data collected by the host device 305.

In the positioning system, the tag device 304 is a tag having functions of RF emission and ultrasonic emission. The receiver system 301 further comprises a sync node for receiving the RF signal emitted from the tag device 304 and performing synchronization, as shown in FIG. 3 by the node having a peripheral ring The sync node may comprise an RF transceiver and an ultrasonic receiver. The sync nodes may be arranged based on coverage of a sync node and the area of the ceiling to be arranged, so as to guarantee coverage of the whole ceiling area with as fewest sync nodes as possible. The sync node may be a sync node dedicated for synchronization, while preferably, it is a receive node further having an RF signal transceiving function.

In addition, in the positioning system, the exemplary receiver system 301 comprises a plurality of receive nodes for receiving ultrasonic signals emitted from the tag device 304. However, completely different from the array or matrix type arrangement in the prior art, arrangement of the receive nodes employs a topology based on a novel idea and is thus more suitable for a complex and varying application scenario.

It is known that in a practical application for example an indoor application, ceilings of a room are not always in a regular square shape, and it is also possible that the ceiling is not a plane, but a stereoscopic shape with a complex structure. In this case, it would be hard to arrange a receiver array with an array type arrangement in the prior art.

Further, calibration or calibration process is also an indispensable step for a Localization and Tracking system, where locations of receivers are usually required to be measured before the system starts working. This calibration work may be called a preparatory step of a practical positioning application. During the calibration process, it is required to manually measure all locations of receivers as reference nodes so as to provide basic data for subsequent actual positioning. According to the prior art, such calibration is usually time-consuming and manpower-consuming and will increase the time for putting the system into practical use.

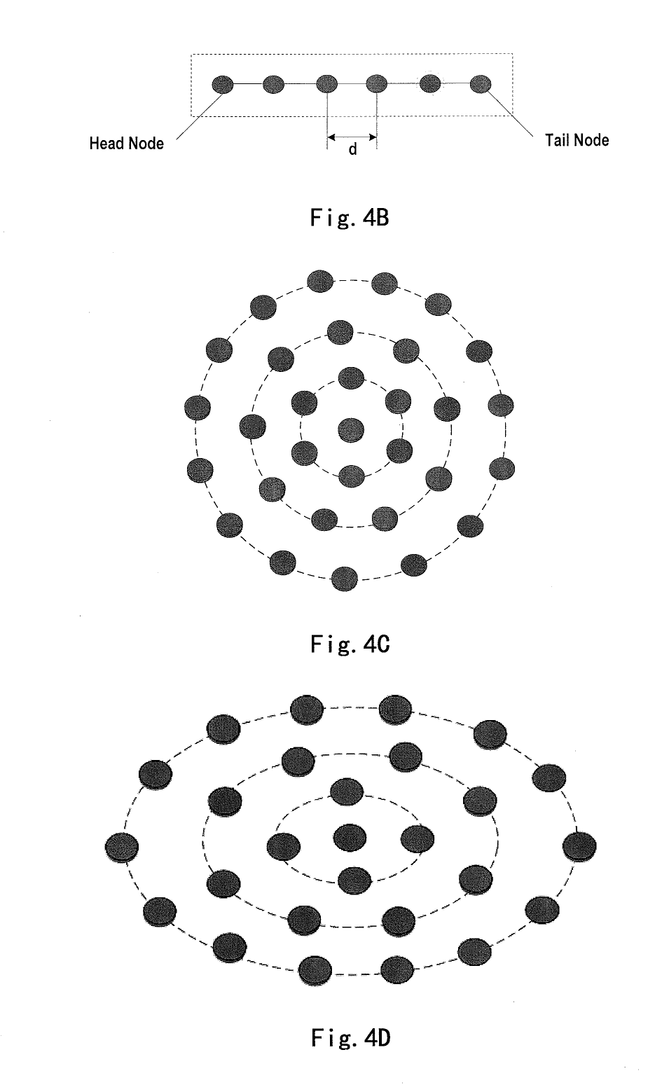

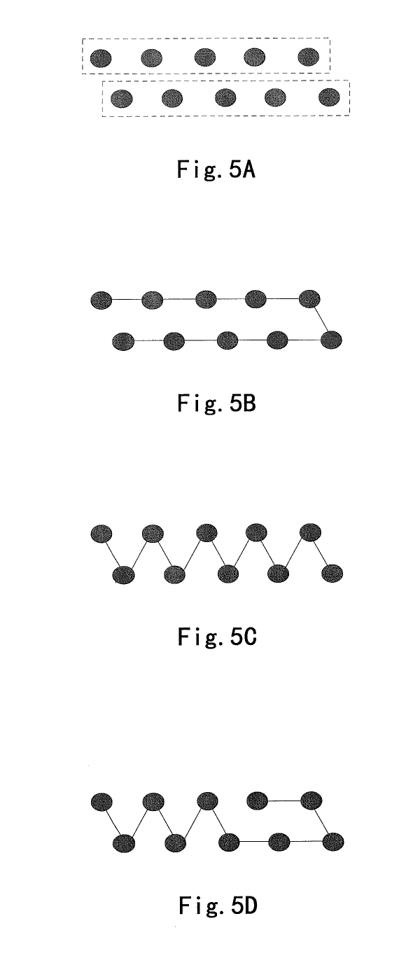

However, according to embodiments of the present invention, there is provided a flexibly configured receiver system, which is more suitable for varying actual application scenarios and may reduce the workload for system calibration. Hereinafter, a completely novel arrangement of a receiver system proposed by these inventors will be depicted with reference to FIG. 4A and FIG. 4B and FIGS. 5A to 5B.

As shown in FIG. 4A, the receiver system comprises for example receiver nodes 1 to 20 connected in serial into a node chain. The receiver system may comprise groups of nodes, which are shown as four in FIG. 4A. Within each group of nodes, these receive node are arranged in a predetermined mode. “A predetermined mode” means the receive nodes are arranged according to a predetermined pattern and a spatial relationship. For example, what is shown in the figure is that the receive nodes in a group of nodes are connected in a straight-line mode and respective nodes may be spaced at predetermined intervals. The intervals may be equal, or the nodes may also be spaced at other predetermined interval manner such as in arithmetic sequence or geometrical sequence.

Partition of groups of nodes may be performed based on a feature of the surface to be arranged. For example, if the surface to be arranged is a plane, one or more groups may be determined based on the shape of the surface to be arranged and the requirement on arrangement density of the receive nodes, where in the more groups, each node is arranged in a predetermined mode, for example in a straight line. Besides, if the surface to be arranged comprises a plurality of planes, nodes to be arranged in different planes may be divided into different big groups, and then in each plane, these big groups may be further subdivided into subgroups based on the shape of the surface to be arranged and the requirement on the arrangement density of the receive nodes.

Additionally, in the exemplary embodiment of FIG. 4A, the direction of a straight line formed by respective group of nodes is flexible, namely, they may have different directions; and the number of nodes in each group is flexible, where they can have different or identical number of receive nodes.

For each group of nodes, it can determine at least one reference node as calibration node, and locations of other receive nodes in each group of nodes may be automatically determined based on the location of the reference node in the group of nodes and information on the predetermined mode. Next, reference will be made to FIG. 4B to describe the determination of a reference node according to an exemplary embodiment of the present invention.

FIG. 4B shows an exemplary group of nodes according to an embodiment of the present invention. As shown in FIG. 4B, the group of nodes is arranged in a straight line, where the group of nodes comprises a head node and a tail node, and the middle nodes are spaced at an equal interval d. However, the present invention is not limited to this, and they may also be spaced according to a distance in conformity with a predetermined mode such as geometrical sequence or arithmetic sequence. According to the embodiment, the reference node may be determined to be the head node or determined to be the tail node, or both of the head node and the tail node are determined as reference nodes. After calibrating the head node and/or tail node as reference node, locations of remaining nodes in the group of nodes may be automatically determined based on the location of the reference node and the information on the straight line mode.

For the sake of illustration, calibrating of nodes will be briefly introduced with the head node and the tail node as calibration reference nodes with reference to the equal interval manner (the interval being d). Suppose the coordinates of the head node and the tail node obtained from manual calibration are (xₕ, yₕ, zₕ) and (zₜ, yₜ, zₜ), respectively, then the coordinates (xᵢ, yᵢ, zᵢ) of the ith middle node between the head node and the tail node may be calibrated as:

$$\{ \begin{matrix}{x}_{i} = {x}_{h} + i \times d \times cos α \\ {y}_{i} = {y}_{h} + i \times d \times cos β \\ {z}_{i} = {z}_{h} + i \times d \times cos γ\end{matrix} \\ Wherein , \\ cos α = \frac{( {x}_{t} - {x}_{h} )}{ρ} \\ cos β = \frac{( {y}_{t} - {y}_{h} )}{ρ} \\ cos γ = \frac{( {z}_{t} - {z}_{h} )}{ρ} , \\ ρ = \sqrt{{( {x}_{t} - {x}_{h} )}^{2} + {( {y}_{t} - {y}_{h} )}^{2} + {( {z}_{t} - {z}_{h} )}^{2}} \qquad formula ( 1 )$$

From the above formula, it may be seen that locations of other nodes are determined based on the direction of the straight line (the angles α, β, γ on the x axis, y axis, and z axis), the predetermined interval d, the coordinates (xₕ, yₕ, zₕ) of the head node located at the head in the straight line, wherein the direction of the straight line is determined based on the head node and tail node.

Though depiction has been made with the head node and tail node as reference nodes, the present invention is not limited thereto. On the contrary, the reference node may be determined as any two receive nodes among the receive nodes, and locations of other receive nodes may be determined based on the direction of the straight line, the predetermined interval, the coordinates of one of the two receive nodes, and its order in the group of receive nodes. However, the direction of the straight line (i.e., the above parameters α, β, γ) may be determined based on the coordinates of the two receive nodes. Besides, the term “order” means what is the sequence number of the reference node in the receive nodes arranged in the straight line.

Thus, the head node and the tail node may be selected as reference nodes, or it can select one of the head node and tail node and any middle node, or any two middle nodes among the group of nodes may be selected as reference nodes.

Besides, according to another embodiment of the present invention, the direction of the straight line is not obtained by calculating two reference nodes as depicted above but is known, for example having been obtained through measurement. Thus, the reference node may be determined as any one of the receive nodes. The locations of the other receive nodes may be automatically determined based on the direction of the straight line, the predetermined interval, the coordinates of the reference node and its order in the group of receive nodes.

In this case, the information on the predetermined mode comprises the direction of the straight line and the predetermined interval for arranging the nodes, and the location information of the reference node comprises the coordinates of the reference node and the order of the reference node in the group of receive nodes.

According to the present invention, the reference node as the calibration reference may be calibrated manually, while the other nodes may be automatically calibrated with a rule of a predetermined arrangement mode. Thus, based on this receiver arrangement manner, it may be adapted to a complex situation of practical application while decreasing the workload of manual calibration, therefore significantly decreasing the mount cost and further decreasing the system cost.

It should be noted that in each group of nodes, the receive nodes may be arranged in a straight line. However, the present invention is not limited thereto, and the receive nodes may also be arranged in a curve or in other predetermined pattern. Next, other embodiments on receiver arrangement will be exemplarily depicted with reference to FIG. 4C and FIG. 4D, wherein FIGS. 4C and 4D show arrangements of the receiver system according to the other two embodiments of the present invention.

As shown in FIG. 4C, the receive nodes are arranged in concentric circles, wherein receive nodes on each circle belong to a same group, and receive nodes in each group are spaced with a predetermined central angle. It is particularly suitable for a spherical or semi-spherical ceiling, and of course also suitable for a planar ceiling with a circular periphery. At the central location, a central receive node may be positioned, or no node is positioned. In the case of positioning a central receive node, it may form a special group individually.

For the receiver system as shown in FIG. 4C, in a group of nodes with the nodes arranged in conformity to a circle, the reference node may be selected as any node of the group of nodes. Based on parameters such as the location of the selected reference node, the location of the center of the circle, the circular radius, the predetermined interval between receive nodes (for example, central angular interval), location coordinates of other nodes may be automatically determined. In this case, information on the predetermined mode comprises location of the center of a circle, the circular radius, and the predetermined interval between receive nodes. The location information of the reference node may comprise coordinates of the reference node.

Next, reference will be made to FIG. 4D, which shows the arrangement of the receiver system substantially similar to FIG. 4C with the difference that the receive nodes in each group are arranged in conformity with an elliptical shape. This arrangement is particularly suitable for a planar ceiling whose periphery is elliptical, or a ceiling in an olivary or semi-olivary shape, for example.

For a group of nodes arranged in conformity with an elliptical shape, any node therein may be determined as the reference node, and then based on, inter alia, the center of the elliptic, the long axis, the short axis, and the interval angle between two nodes, the coordinate locations of other nodes may be automatically determined. In this case, the information on the predetermined mode comprises the center, the long axis and the short axis of the elliptic, and the interval angle between nodes, while the location of the reference node may comprise the coordinates of the reference node.

Under the teaching herein and the knowledge of a normally skilled person in the art, those skilled in the art may completely implement the formula used for calibrating the systems as shown in FIGS. 4C and 4D. Thus, for the sake of clarity, it will not be detailed here.

Further, it should be noted that the above depictions on circular and elliptical arrangements are only for exemplary purpose, and the present invention may also employ other predetermined mode. For example, it may be arranged in an arc, a helical curve, and any other predetermined pattern, etc. Moreover, a normally skilled person in the art can select, based on the teaching the present invention, a suitable reference calibration node in accordance with features of these curves.

Further, it should be noted that in different groups of nodes, the node arrangement mode may be identical, or different, where the arrangement mode in each group may be determined based on the feature of the ceiling area positioning the group of nodes.

Further, it should be further noted that determining the above reference point is also exemplary. As appreciated by those skilled in the art, there may be other manners for determining a reference node. However, these manners may be easily envisaged based on the knowledge of a normally skilled person in the art and the teaching offered by the disclosure of the present invention. Thus, for the sake of clarity, it will not be detailed here.

According to an embodiment of the present invention, respective nodes in the receiver system may communicate with for example a host device in wireless manner, or connected together in a cabled manner and further connected to the host device.

In practical application, a low cost and reliable cable is preferably selected, for example a controller area network bus CAN-bus, to connect them together. Preferably, they are connected in series into a chain. As shown in FIG. 4A, the receive nodes in each group of nodes are connected in series and connected to another group of nodes in series. However, the present invention is not limited thereto. In other words, the connection is not limited to intra-group connection, as long as they are connected in series as a whole. FIGS. 5A to 5D show examples of node connection manners.

FIG. 5A shows two groups of nodes to be connected, which comprise a plurality of nodes arranged in a straight line, respectively. FIG. 5B shows a connection manner of straight-line connection within a group, wherein nodes in each group are connected in series, and the two groups of nodes are also connected in series. Different from FIG. 5B, FIG. 5C shows a connection manner of W-line connection, wherein nodes in each group are connected to nodes in another group to form a node chain. Besides, a combined connection manner as shown in FIG. 5D may also be employed, in other words, some of them use the W-line connection, while some use the straight line connection.

Further, it should be noted that the above chain manner may be readily applicable to a circumstance of circle or elliptic. For the sake of clarity, it will not be detailed here.

In an actual application scenario, the ceiling condition of a ceiling is complex. The ceiling may be located in one plane, but the peripheral shape is not suitable for a matrix arrangement, or though the periphery of the ceiling is square, the ceiling is not in a plane, but has a plurality of levels. In such as case, according to the present invention, at least one group of nodes are arranged in a different plane from other group of nodes. And in this case, the matrix arrangement in the prior art is not suitable and even impossible to be put into practical use. In contrast, the arrangement of receiver system as provided in the present invention is very flexible, which may be practically applied in various kinds of complex application environments, and its connection manner is also very flexible. In addition, according to the present invention, workload for manual calibration may be significantly reduced through automatic calibration.

Further, it should be noted that in the above embodiment, for example, for a circular or elliptical ceiling, a spherical or semi-spherical top, or an olivary or semi-olivary top, it is suggested to employ a circular or elliptic arrangement within each group. However, the present invention is not limited thereto. For a planar ceiling whose periphery is circular or elliptic, string-line arrangement may also be employed according to its shape. For a spherical or semi-spherical top, or an olivary or semi-olivary top, if the top space is quite large and variation of the top curvature is quite small relative to the interval between receive nodes, a straight line can be approximated in a suitable predetermined area.

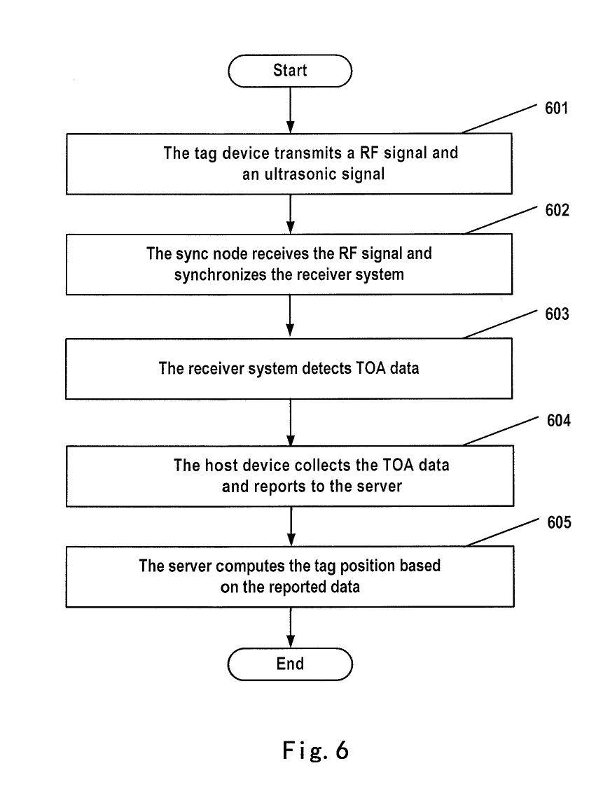

Next, the work flow of the positioning system according to the present invention will be described with reference to FIG. 6.

As shown in FIG. 6, first at step 601, the tag device 304 emits an RF signal as a synchronizing signal and an ultrasonic signal as a ranging signal.

The sync node having an RF receive function in the receiver system 301 receives the RF signal at step 602, and based on the RF signal, the synchronization of the receiver system with the tag device 304 is done. For example, a sync signal line is set as a high level to thereby start each receive node in the receiver system, so as to subsequently receive the ultrasonic signal emitted from the tag device. The receiver system 301 may have a plurality of sync nodes therein. Synchronization may be performed as long as any one of the sync nodes receives the sync signal.

Next, at step 603, a receive node in the receiver system receives the ultrasonic signal and detects the arrival of time TOA data.

Next at step 604, the host device collects the TOA data and reports to the server. At step 605, the server calculates the location of the tag device based on the report data.

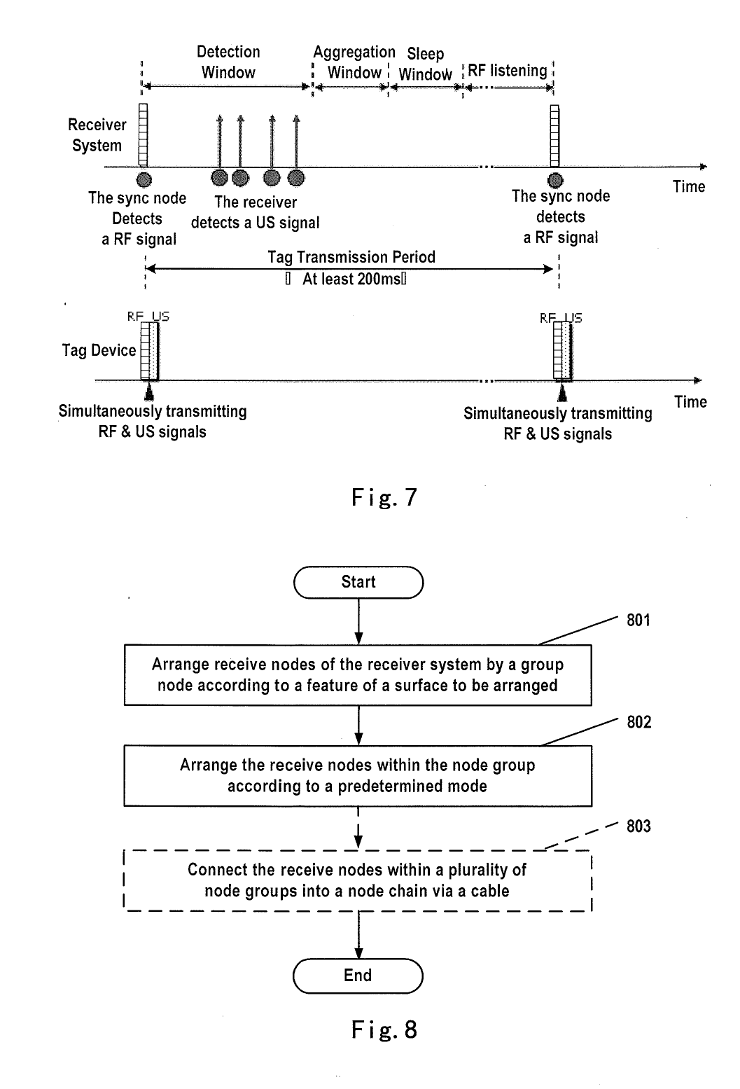

In the positioning system, system coordination work is performed by the host device 305. Hereinafter, detailed depictions will be made with reference to FIG. 7, which shows a time chart of the positioning system.

As shown in FIG. 7, the tag device, upon the begin of for example at least 200 ms tag emission period, emits an RF signal as a sync signal and an ultrasonic signal as a ranging signal simultaneously. Any sync node in the receiver system detects an RF signal and performs synchronization to thereby start the remaining receive nodes. Meanwhile, a detection window for ultrasonic listening is opened, with a width of for example 70 ms. Some receive nodes in the receiver system will receive the ultrasonic signal sent from the tag device in the detection window and detects the TOA data. Upon the end of the detection window, the host device will open an aggregation window with a width of for example 15 ms. In the aggregation window, the host device collects the TOA data and reports to the server. Preferably, after the end of the aggregate window, it enters into a sleep window (for example 15 ms) during which all nodes in the receiver system will be switched off, including the sync node, so as to prevent error caused by long-time running. Upon the end of the sleep window, it enters into an RF listening period, and a next process will be re-started when any sync node detects a new RF signal.

In the positioning system according to the present invention, the tag device initiatively emits without being controlled by a controller, such that the coordination work is simplified, and a more effective system coordination may be achieved. Further, according to the positioning system of the present invention, synchronization is also started by the tag device, and the sync mechanism can be more precise, to thereby further improve the positioning precision.

It should be noted that though the embodiment of transmitting a sync signal and a ranging signal simultaneously has been described above, the present invention is not limited thereto. The ranging signal may also be transmitted later than the ranging signal so as to further guarantee that the receiver has prepared well before the ranging signal arrives at the receiver.

Further, it should be noted that the widths of the above respective time windows are only exemplary, and the present invention is not limited thereto. For example, the detection window may be adjusted based on the environment condition in practical application, for example tag density, detection distance, etc.

Further, it should be noted that in the above embodiment depicted with reference to FIG. 3, there is shown a host device 305 connected to the receiver system. However, the present invention is not limited thereto. For example, the host device 305 may also be incorporated into a node in the receiver system.

Further, it should be noted that in the above embodiment, the server carries out the work of calculating the 3D position of the tag. However, the present invention is not limited thereto.

In fact, the location calculation function may also be incorporated into the host device 305 or into a node in the receiver system together with the host device 305.

Besides the receiver system and the positioning system comprising the receiver system according to the present invention as depicted above, the present invention further provides a method for arranging a receiver system. Hereinafter, it will be depicted with reference to FIG. 8.

As shown in FIG. 8, first at step 801, receive nodes in the receiver system are arranged by a group of nodes according to a feature of a surface to be arranged. In different applications, the ceiling to be arranged has different features. For example, the ceiling may have a special shape or a special structure. When arranging the receiver, the receiver system to be arranged may be divided into several groups adapted to the ceiling. These groups may be in a same plane, or may be in different planes.

Next, at step 802, receive nodes are arranged in a predetermined mode within a group of nodes. For example, within each group of nodes, the receive nodes are arranged in a straight line or in conformity with a predetermined curve. It should be noted that in different groups of nodes, the node arrangement modes may be identical, or different, where the arrangement modes may be determined based on the feature of the ceiling area in which the group of nodes is positioned. For example, if the ceiling area related to the group of nodes is a plane or in other form in which nodes may be arranged in a straight line, the nodes are arranged in a straight line at a predetermined interval. For a spherical ceiling, nodes in each group may be arranged in conformity with a circle.

Next, at step 803, preferably, receive nodes in a plurality of groups of nodes are connected in series via a cable. For example, the receiver system may be connected into a chain through the above mentioned CAN-bus, for example in a straight line, curve line, or W-line connection, or any combined connection manner thereof.

Further, at least one reference node as a calibration reference may be selected from each group of nodes, and other receive nodes in each group of nodes may be automatically calibrated based on calibration of the reference node in the group of nodes.

For a group of nodes where the nodes are arranged into a straight line at a predetermined interval, one or more of the head node, tail node, and middle nodes in the straight line as previously mentioned may be determined as reference nodes, and for a group of nodes arranged in a curve, a proper reference node may be selected based on a feature of the curve.

Then, the reference node selected in each group of nodes may be calibrated, while the remaining nodes are automatically calibrated based on their arrangement mode and the coordinates of the calibrated reference node.

In the receiver system, at least one of the plurality of receive nodes may be a sync node configured to further receive a sync signal for synchronizing the plurality of receive nodes. Moreover, at least a part of nodes in the plurality of receive nodes may be located in a different plane from the remaining nodes.

According to the receiver system, positioning system and the arrangement manner of the receiver system as proposed by the present invention, flexible architecture and easy calibration may be implemented, and an effective coordination and high precision may be further achieved.

It should be noted that though the embodiments in which the RF signal is a sync signal and the ultrasonic signal is a ranging signal have been depicted hereinbefore, the present invention is not limited thereto. According to the present invention, the sync signal may also be a laser, infrared, microwave, visible light signal or the like, while the ranging signal may also be infrared or RF, etc.

It should be noted that the receiver system of the present invention may also be applied to for example a traditional positioning system as provided in the Background of the Invention (a system which does not include a sync receiver, and not employ the coordination mechanism as provided in the present invention), besides the system of the present application.

Further, the embodiments of the present invention can be implemented in software, hardware or the combination thereof. The hardware part can be implemented by a special logic; the software part can be stored in a memory and executed by a proper instruction execution system such as a microprocessor or a dedicated designed hardware. The normally skilled in the art may understand that the above method and system may be implemented with a computer-executable instruction and/or in a processor control code, for example, such code is provided on a bearer medium such as a magnetic disk, CD, or DVD-ROM, or a programmable memory such as a read-only memory (firmware) or a data bearer such as an optical or electronic signal bearer. The system and its components in the present embodiment may be implemented by hardware circuitry of a programmable hardware device such as a very large scale integrated circuit or gate array, a semiconductor such as logical chip or transistor, or a field-programmable gate array, or a programmable logical device, or implemented by software executed by various kinds of processors, or implemented by combination of the above hardware circuitry and software, for example firmware.

Though the present invention has been depicted with reference to the currently considered embodiments, it should be appreciated that the present invention is not limited the disclosed embodiments. On the contrary, the present invention intends to cover various modifications and equivalent arrangements falling within the spirit and scope of the appended claims. The scope of the appended claims accords with the broadest explanations and covers all such modifications and equivalent structures and functions.

What is claimed is:

1. A receiver system for positioning, comprising:
a group of nodes, comprising receive nodes for receiving a ranging signal,
in the group of nodes, the receive nodes being arranged in a predetermined mode, and the group of nodes comprising a reference node, wherein locations of other receive nodes within the group of nodes can be determined based on information on the predetermined mode and the location of the reference node.

2. The receiver system according to claim 1, wherein the receive nodes are arranged in a straight line at a predetermined interval.

3. The receiver system according to claim 2, wherein the reference node is determined as one of the receive nodes, and locations of the other receive nodes are determined based on a direction of the straight line, the predetermined interval, coordinates of the reference node, and its order in the group of receive nodes.

4. The receiver system according to claim 2, wherein the reference node is determined to be two receive nodes among the receive nodes, and locations of the other receive nodes are determined based on a direction of the straight line, the predetermined interval, coordinates of one of the two receive nodes and its order in the group of receive nodes, wherein a direction of the straight line is determined based on coordinates of the two receive nodes.

5. The receiver system according to claim 4, wherein the two receive nodes are a head receive node and a tail receive node among the receive nodes.

6. The receiver system according to claim 1, wherein the receive nodes are arranged in conformity with a circle at a predetermined interval, and wherein the reference node is determined as one of the receive nodes, and locations of the other receive nodes are determined based on a center of the circle, a radius of the circle, the predetermined interval, and the coordinates of the reference node.

7. The receiver system according to claim 1, wherein at least one of the receive nodes is a sync node further configured to receive a sync signal for synchronizing the receive nodes.

8. The receiver system according to claim 1, wherein the receiver system comprises a plurality of groups of nodes, and wherein at least one group of nodes is configured to be located in a different plane from other groups of nodes.

9. The receiver system according to claim 8, wherein receiver nodes in the plurality of the group of nodes are connected into a node chain through cables.

10. The receiver system according to claim 9, wherein the receive nodes are connected in a straight line, a W-line or a combination thereof.

11. A method for arranging a receiver system, comprising:
arranging receive nodes of the receiver system by a group of nodes according to a feature of a surface to be arranged; and
arranging the receive nodes within the group of nodes in a predetermined mode;
wherein the group of nodes may comprise a reference node, and locations of other receive nodes within the group of nodes may be determined based on information on the predetermined mode and location of the reference node.

12. The method according to claim 11, wherein arranging the receive nodes in a predetermined mode comprises arranging the receive nodes in a straight line at a predetermined interval.

13. The method according to claim 12, wherein the reference node is determined as one of the receive nodes, and locations of the other receive nodes are determined based on a direction of the straight line, the predetermined interval, coordinates of the reference node, and its order in the group of receive nodes.

14. The method according to claim 12, wherein the reference node is determined to be two receive nodes among the receive nodes, and locations of the other receive nodes are determined based on a direction of the straight line, the predetermined interval, coordinates of one of the two receive nodes and its order in the group of receive nodes, wherein a direction of the straight line is determined based on coordinates of the two receive nodes.

15. The method according to claim 14, wherein the two receive nodes are a head receive node and a tail receive node among the receive nodes.

16. The method according to claim 11, wherein arranging the receive nodes in a predetermined mode comprises: arranging the receive nodes in conformity with a circle at a predetermined interval, and wherein the reference node is determined to be one of the receive nodes, and locations of the other receive nodes are determined based on a center of the circle, a radius of the circle, the predetermined interval, and the coordinates of the reference node.

17. The method according to claim 11, wherein at least one of the receive nodes is a sync node further configured to receive a sync signal for synchronizing the receive nodes.

18. The method according to claim 11, wherein the receiver system is arranged by a plurality of the groups of nodes, and wherein at least one group of nodes is configured to be located in a different plane from other groups of nodes.

19. The method according to claim 18, further comprising:
connecting the receive nodes within the plurality of groups of nodes into a node chain via cables.

20. The method according to claim 19, wherein the plurality of receive nodes are connected in a straight line, a W-line or a combination thereof.
